(19) United States
(12) Patent Application Publication
(10) Pub. No.: US 2007/0089124 A1
(43) Pub. Date: Apr. 19, 2007

(54) Method and system of distributing pre-released media content

(76) Inventor: Madison E. Bond, Philadelphia, PA (US)

Correspondence Address: BROOKS KUSHMAN P.C., 1000 TOWN CENTER, TWENTY-SECOND FLOOR, SOUTHFIELD, MI, 48075, US

(21) Appl. No.: 11/249,201

(22) Filed: Oct. 13, 2005

(51) Int. Cl. H04N 7/173; H04N 7/16

(52) U.S. Cl. 725/8; 725/86; 725/87

(57) ABSTRACT

Method and system of controlling access to pre-release media content. The method and system include features to assess whether a customer has agreed to purchase a personal copy of the pre-released media content and to control access to the media content as a function thereof.

### BACKGROUND OF THE INVENTION

1. Field of the Invention

The present invention relates to methods and systems of distributing pre-released media content.

2. Background Art

Media content owners, such as those producing movies, music, television programs, and the like may limit availability of newly released products. For example, movie studios may limit distribution of a new movie according to the following series of events: a first stage (1) wherein the movie is availability of for viewing in first run theaters for a limited period of time at a price of approximately $8-10 per ticket; a second stage (2) wherein the movie is availability for viewing in second run theaters for a limited period of time at a price of approximately $1-3 per ticket; a third stage (3) wherein personal copies (DVDs, file downloads, etc.) of the movie are available through retail stores for purchase at a price of approximately $15-20; a fourth stage (4) wherein cable service providers may offer limited on-demand or pay-per-view viewing of the movie at a price of approximately $3.99 for a 24-hour viewing window; a fifth stage (5) wherein cable television providers may offer the movies for free viewing on premium channels; and a sixth stage (6) wherein cable system providers may offer the movies for free viewing on cable or network television channels.

Cable system providers and other media content providers are unable to distribute media content until the stage 4, well after content has been available in theaters and at retail stores.

### SUMMARY OF THE INVENTION

One non-limiting aspect of the present invention relates to a method of enabling media content providers to distribute media content prior to the above described stage 4.

One non-limiting aspect of the present invention relates to a method of distributing pre-released media content over an electronic network to subscribers of a media service provider. The method may include receiving a request from a subscriber for pre-released media content, processing the request to determine whether the subscriber has committed to purchasing a personal copy of the pre-released media content, and transmitting the requested pre-released media content over the electronic network to the subscriber if the subscriber has committed to purchasing the personal copy of the pre-released media content.

The method may further include receiving a request for released media content from the subscribers and transmitting the released media content to the subscribers without requiring the subscriber to commit to purchasing a personal copy of the released media content.

The method may further include characterizing the released media content as media content available through cable on-demand or pay-per-view applications and characterizing the pre-released media content as media content not available through cable on-demand or pay-per-view applications.

The method may further include configuring the transmitted pre-released media content to be available to the subscriber for a limited period of time, such as until the subscriber receives the personal copy of the media content.

The method may further include delivering the personal copy of pre-released media content to the subscriber separately from the transmission of the requested pre-released media content over the electronic network, such as through a non-electronic courier.

The method may further include configuring the transmitted media content for playback on customer equipment associated with the subscriber.

The method may further include receiving the request through a graphical user interface (GUI) associated with the customer equipment, such as through a settop box associated with the subscriber.

One non-limiting aspect of the present invention relates to an electronic programming guide (EPG) for use by a cable system provider. The EPG may include a navigable channel map associated with cable television channels offered by the cable system provider such that user may select channels from the channel map for viewing. The EPG may further include a pay-for-purchase menu associated with media content offered by the cable system provider wherein the pay-for-purchase menu includes pre-released media content that may only be viewed if the user commits to purchasing a personal copy thereof.

The pay-for-purchase menu may also include released media content that may be viewed without committing to purchasing the personal copy thereof.

The pay-for-purchase menu may be associated with on-demand viewing of the media content.

The pay-for-purchase menu may coordinate transmission of an electronic message to the cable system provider indicating the commitment of the user to purchasing the person copy of the pre-released media content.

One non-limiting aspect of the present invention relates to a method for use by a cable television provider to distribute movies available only on DVD to cable television subscribers. The method may include offering movies to customers through a cable system interface and electronically transmitting one or more movies from the provider to the customer over an electronic network if the customer commits to purchasing a personal DVD copy of the one or more movies.

The method may further include delivering the personal DVD copy of the one or more movies to the subscribers after electronically transmitting the one or more movies to the subscribers.

The method may further include delivering the personal DVD copy of the one or more movies to the subscriber via an electronic file download.

The method may further include delivering the personal DVD copy of the one or more movies to the subscriber via non-electronic courier.

The method may further include transmitting the movies in a time-dependent format such that the transmitted movies are available to the subscriber for viewing for a limited period of time.

One non-limiting aspect of the present invention relates to a method of distributing pre-released media content to subscribers of a media service provider, the pre-released media content characterized as being available only through personally purchased copies of the media content. The method may include tying personal purchasing of the pre-released media content to transmission of media content signals associate therewith, and transmitting signals associated with requested pre-released media from the media service provider to the subscribers over an electronic network if the subscribers commit to purchasing a personal copy of the pre-released media content.

The above features and advantages, along with other features and advantages of the present invention, are readily apparent from the following detailed description of the invention when taken in connection with the accompanying drawings.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawing in which:

FIG. 1 illustrates a system of distributing media content in accordance with one non-limiting aspect of the present invention.

### DETAILED DESCRIPTION OF THE PREFERRED EMBODIMENT(S)

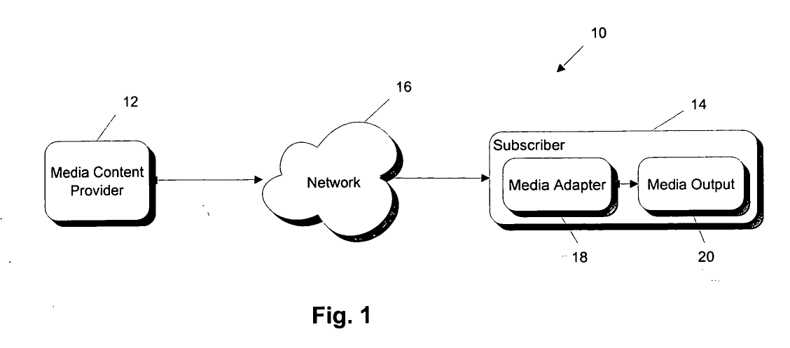

FIG. 1 illustrates a system 10 for distributing media content in accordance with one non-limiting aspect of the present invention. The media content may relate to movies, music, games, television programs, and other electronically available media. The system 10 may include a media content provider 12 for coordinating or otherwise controlling transportation signals associated with the media content to one or more subscribers 14.

A network 16 may be included to electronically transport the media content signals between the media provider 12 and the subscribers 14. The subscribers 14 may include customer equipment to facilitate playback or other interfacing with the media content, such as a media adapter 18 for manipulating and otherwise formulating the media content for playback on a media output device 20, such as a television or other display.

The media provider 12 may be a cable system operator or headend unit, a telecommunications operator, or other operator having capabilities for electronically transporting signals to its subscribers 14. The signals may be transported over any number of networks, such as cable networks and telecommunication networks. The network 16 may be include any number of mediums for transporting the signals, such as coaxial cable, optic cable, terrestrial or extraterrestrial wireless, etc.

The media adapter 18 may be a settop box (STB), outlet digital adapter (ODA), or other feature configured to manipulate the signals received from the media content provider 12. The media output device 20 may be a television, computer, media terminal adapter (MTA), or other unit configured to receive media content. Of course, the present invention contemplates any number of features and configurations and is not intended to be limited to the foregoing. In particular, the media adapter 18 and output 20 need not be separate features as they can be integrated into a common device or element.

The system 10 may be configured to distribute pre-released media content to its subscribers 14. The pre-released media content may be associated with media content which is otherwise only available before stage 4 of a distribution environment which includes the following series of events: a first stage (1) wherein the movie is availability of for viewing in first run theaters for a limited period of time at a price of approximately $8-10 per ticket; a second stage (2) wherein the movie is availability for viewing in second run theaters for a limited period of time at a price of approximately $1-3 per ticket; a third stage (3) wherein personal copies (DVDs, file downloads, etc.) of the movie are available through retail stores for purchase at a price of approximately $15-20; a fourth stage (4) wherein cable service provides may offer limited on-demand or pay-per-view viewing of the movie at a price of approximately $3.99 for a 24-hour viewing window; a fifth stage (5) wherein cable television providers may offer the movies for free viewing on premium channels; and a sixth stage (6) wherein cable system providers may offer the movies for free viewing on cable or network television channels.

The pre-released media content may be electronically transmitted from the media content provider 12 or other entity associated therewith to the subscribers 14 if the subscribers 14 commit to purchasing a personal copy of the media content. The pre-released media content may be selected form a user interface operating at the subscriber locations (not shown), such as through an electronic programming guide (EPG) if the media adapter is a STB and/or through a webpage or other interface if the media adapter is a computer, mobile devices, or other feature.

With respect to the EPG application, the pre-released media content may be offered through a navigable pay-for-purchase menu wherein pre-released media content may be displayed for selection. Optionally, an additional commitment button (not show) or other feature may be provided to receive a user input associated with indicating whether the user agrees to purchase a personal copy of the pre-released media content, in which case the cost associated with the purchase may be automatically added to a subscriber account. Of course, the present invention contemplates any number of features and configurations for receiving the subscriber commitment, such through a telephone call, button on a remote control, and others.

The EPG may include other menus, such as a navigable channel map menu or navigable released media content database. The released media content menu may be provided to facilitate ordering released media content for pay-per-view or on-demand viewing without requiring the subscriber to commit to purchasing a personal copy of the selected media content. The released media content menu may also include features to facilitate purchasing a personal copy of the released media content. Optionally, the navigable channel map menu may be associated with cable television channels offered by a cable system provider for viewing such that a user may select channels from the channel map for viewing.

The media content provider 12 may transmit the pre-released media content separately form the personal copy thereof. For example, the media provider 12 may stream the pre-released media content from pay-per-view or on-demand servers over existing cable infrastructure for playback on the media output device and separately ship a personal copy (DVD) of the media content to the subscriber through a non-electronic courier. However, the present invention contemplates that the personal copy may be delivered electronically through a file download operation or other operation.

With respect to cable systems, for example, the present invention is particularly advantageous because it enables cable system operator to deliver pre-released media content through existing pay-per-view and on-demand infrastructures as long as the subscribers commit to purchasing a personal copy thereof. In this manner, such operators may offer subscribers video content earlier in the distribution cycle than that dictated by media content owners (i.e., the studios, producers, and other individuals creating the media content).

By requiring subscribers to purchase a personal (DVD) copy of a pre-released media content in order to view the media content via PPV, the present invention is able to offer media content to subscribers much earlier than previously possible without adversely affecting the profits of the content owners. In fact, DVD sales may actually increase due to the additional retail avenue provided by the present invention.

Moreover, the present invention may be attractive to subscribers as it permits the subscriber to purchase personals copies with the press of a button, rather than requiring a trip to the store. Furthermore, the personal copies may be charged directly to the subscribers account for billing with the subscriber's regular cable bill and thereby eliminate the hassle of executing a separate credit card transaction, as would be required with an online purchase. In this way, customers may be inclined to order more PPV movies than in the past due to the media content being available sooner (i.e., closer in time to the left first run theaters).

In addition, the present invention may be attractive to media content providers and media content owners as they may profit from the sale of the personal copies of these pre-released media content without incurring additional overhead to offer the pre-released media content through existing pay-per-view or on-demand menus, and certainly less overhead than retail stores require to market and sell DVDs. As such, the media content providers may potentially offer personal copies of the pre-released media content a lower price than is available through other channels.

In accordance with one non-limiting aspect of the present invention, the media content providers are enabled to distribute the media content prior to stage 4 if subscribers commit to purchasing a personal copy of the media content.

In accordance with one non-limiting aspect of the present invention, media content may be offered to subscribers earlier in the distribution cycle by allowing subscribers to purchase a personal DVD copy of the movie concurrently with when the DVDs are available for purchase in stores.

In accordance with one non-limiting aspect of the present invention, the purchasing of such pre-released media content (i.e., content made available before the stage 4 or when available on DVD) may be integrated into menus, guides, and other features provided by the media content providers. For example, a pay-for-purchase menu, such as those commonly associated with pay-per-view and on-demand services, may be integrated into cable system electronic programming guides (EPGs). Additionally, other released media content may be integrated into such menus to permit subscribers to purchase the released content and receive a permanent copy concurrently or at a later time.

In accordance with one non-limiting aspect of the present invention, the pay-for-purchase menu may provide a listing of pre-released media content (movies, music, television programs, games, etc.) that content owners are offering for sale as DVDs through retail stores (stage 3), or through other forms of permanent/personal ownership. A selected pre-released movie may be made available to the subscriber for a 24-hour viewing window, or alternatively may be available in their “Saved Programs” file or the like for a reasonable amount of time (e.g., 2-3 weeks) until the DVD copy of the movie arrives at their home. For media content which is not as current (released), and thus are available for normal PPV selection (stage 4), a DVD purchase option and associated extended viewing window may also be made available to the subscriber, but would not be a requirement for viewing the media content. As an incentive, the pay-per-view (PPV) fee may be waived if the subscriber chose to purchase a DVD copy of the selected media content.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of distributing pre-released media content over an electronic network to subscribers of a media service provider, the method comprising:
receiving a request from a subscriber for pre-released media content;
processing the request to determine whether the subscriber has committed to purchasing a personal copy of the pre-released media content; and
transmitting the requested pre-released media content over the electronic network to the subscriber if the subscriber has committed to purchasing the personal copy of the pre-released media content.

2. The method of claim 1 further comprising receiving a request for released media content from the subscribers and transmitting the released media content to the subscribers without requiring the subscriber to commit to purchasing a personal copy of the released media content.

3. The method of claim 2 further comprising characterizing the released media content as media content available through cable on-demand or pay-per-view applications and characterizing the pre-released media content as media content not available through cable on-demand or pay-per-view applications.

4. The method of claim 1 further comprising configuring the transmitted pre-released media content to be available to the subscriber for a limited period of time.

5. The method of claim 4 further comprising configuring the transmitted pre-released media content to be available until the subscriber receives the personal copy of the media content.

6. The method of claim 1 further comprising delivering the personal copy of pre-released media content to the subscriber separately from the transmission of the requested pre-released media content over the electronic network.

7. The method of claim 6 further comprising delivering the personal copy through a non-electronic courier.

8. The method of claim 1 further comprising configuring the transmitted media content for playback on customer equipment associated with the subscriber.

9. The method of claim 8 further comprising receiving the request through a graphical user interface (GUI) associated with the customer equipment.

10. The method of claim 9 further comprising providing the GUI through a settop box associated with the subscriber.

11. An electronic programming guide (EPG) for use by a cable system provider, the EPG comprising:
a navigable channel map associated with cable television channels offered by the cable system provider such that user may select channels from the channel map for viewing; and
a pay-for-purchase menu associated with media content offered by the cable system provider wherein the pay-for-purchase menu includes pre-released media content that may only be viewed if the user commits to purchasing a personal copy thereof.

12. The EPG of claim 11 wherein the pay-for-purchase menu includes released media content that may be viewed without committing to purchasing the personal copy thereof.

13. The EPG of claim 11 wherein the pay-for-purchase menu is associated with on-demand viewing of the media content.

14. The EPG of claim 11 wherein the pay-for-purchase menu coordinates transmission of an electronic message to the cable system provider indicating the commitment of the user to purchasing the person copy of the pre-released media content.

15. A method for use by a cable television provider to distribute movies available only on DVD to cable television subscribers, the method comprising:
offering movies to customers through a cable system interface; and
electronically transmitting one or more movies from the provider to the customer over an electronic network if the customer commits to purchasing a personal DVD copy of the one or more movies.

16. The method of claim 11 further comprising delivering the personal DVD copy of the one or more movies to the subscribers after electronically transmitting the one or more movies to the subscribers.

17. The method of claim 12 further comprising delivering the personal DVD copy of the one or more movies to the subscriber via an electronic file download.

18. The method of claim 12 further comprising delivering the personal DVD copy of the one or more movies to the subscriber via non-electronic courier.

19. The method of claim 11 further comprising transmitting the movies in a time-dependent format such that the transmitted movies are available to the subscriber for viewing for a limited period of time.

20. A method of distributing pre-released media content to subscribers of a media service provider, the pre-released media content characterized as being available only through personally purchased copies of the media content, the method comprising:
tying personal purchasing of the pre-released media content to transmission of media content signals associate therewith; and
transmitting signals associated with requested pre-released media from the media service provider to the subscribers over an electronic network if the subscribers commit to purchasing a personal copy of the pre-released media content.
